(19) United States
(12) Patent Application Publication
(10) Pub. No.: US 2008/0243037 A1
(43) Pub. Date: Oct. 2, 2008

(54) Therapeutic method for scolioses

(76) Inventor: Maria Antonietta Fusco, Avellino (IT)

Correspondence Address: Leffert Jay & Polglaze, P.A., P.O. Box 581009, Minneapolis, MN, 55458-1009, US

(21) Appl. No.: 11/732,050

(22) Filed: Apr. 2, 2007

(51) Int. Cl. A61H 1/00

(52) U.S. Cl. 601/28; 128/898

(57) ABSTRACT

A therapeutic method for the correction of scoliosis, comprising a step of applying a pressure stimulation at one or more selected insertion points of intrinsic muscles of the foot plant, so as to affect sensorial afferences coming from the foot plant, and a step of stimulation of cranial receptors.

### FIELD OF THE INVENTION

The present invention relates to a diagnostic and a therapeutic method for the treatment of scolioses.

### BACKGROUND OF THE INVENTION

In his treatise “Peri' Arthron”, Hippocrates, after classifying angular curves and deformities, describes a reduction method for scoliosis based upon a series of artifices still used today, namely reduction frames, longitudinal traction, pressures onto gibbosities.

One millennium later, in about 1300, Paolo d'Egina tried to gradually correct scoliosis by means of splinted bendages.

In 1582 Ambroise Paré taught how to manufacture metallic jackets to be applied to the trunk of people affected by scoliosis.

No important therapeutic developments have been made until our century, when Hibbs, in 1931, (Hibbs R., Risser J. C., Ferguson A. B.—Scoliosis Treated By the Fusion Operation. J. Bone Jt. Surg., 13, pp. 91-104, 1931), performed the first surgical operation of spinal arthrodesis and, in 1958, Blount and Schmidt developed the so-called Milwaukee corset (Blount W. P., Schmidt A., Bidwell R. G.—Making the Milwaukee brace. J. Bone Jt. Surg., 40-A, pp. 526-528, 1958).

However, the attempts at explaining the scoliosis aetiology and at subjecting it to an efficient treatment have been fruitless during the centuries. Accordingly, literature refers that no treatment is possible for the spinal deformities.

Idiopathic scoliosis is often defined (Guidelines SINFER, “Società Italiana Medicina Fisica e Riabilitazione”, http://www.simfer.it/) as a complex structural deformity of the vertebral column which twists on the three space planes. Onto the front plane it reveals itself with a side flexion motion, onto the sagittal plane with a curve alteration, most often by causing an inversion thereof, and onto the axial plane with a rotation motion. By definition—and already mentioned above—a known cause and probably not even a single cause explains idiopathic scoliosis. Therefore, from an aetiopathogenetic point of view the vertebral deformation caused by idiopathic scoliosis can be defined as the indication of a complex syndrome with multifactorial aetiology. This syndrome appears almost always with the deformity alone, but it does not identify therewith since with a more detailed analysis it is possible to find other sub-clinical indications which seem to be meaningful.

Scoliosis is also often associated (Scoliosis Research Society, http://www.srs.org/) with a curve of more than 10° Cobb onto the front plane without considering the side plane, the modifications of which significantly influence the scoliosis progress and the orthesic treatability. Based upon these data, several published works concerned with the scoliosis' conservative treatment efficiency (physical therapy, plastered corsets, jackets) utilize the modification of Cobb's degrees as the only parameter to assess scoliosis itself and its progress. This aspect will be revised in the future, in particular by considering the importance of the vertebral rotation, assessable both radiographically and clinically.

According to other Authors (S. Negrini and P. Sibilla at www.gss.it), scoliosis is a pathology which, when getting worse, can cause serious deformations, namely side deviations of the vertebral column, rotation of the vertebrae and of the costae, and flat back. Furthermore, it may cause organic dysfunctions. In particular, in presence of dorsal scoliosis of large entity, a reduction in pulmonary expansion can occur, with a reduction in the oxygen transportation to the tissue.

As can be noted from the above analysis of the state of the art, the most utilized definitions of scoliosis nowadays describe mainly the associated modification of the column asset.

15% of scoliosis are caused by known diseases, whereas the remaining 85% of scoliosis are classified as idiopathic, because scoliosis is the only symptom that appears in young people.

Idiopathic scoliosis is a pathology defined as multifactorial. Genetic factors would play a role therein. According to recent researches, the neurological factors seem to be the most involved ones.

Idiopathic scoliosis shows itself with peculiar symptoms, which must be carefully evaluated by the specialist in order to perform a differential diagnosis. The clinical examination which allows distinguishing the real scoliosis from the scoliotic attitude is the so-called Bending Test (forward trunk flexion with outstretched legs and joined hands). If there is an initial scoliosis, one or more projections (gibbosities) form on one side of the column (at dorsal and/or lumbar level). If on the back there are asymmetries when standing, but not when flexing the trunk forwards, the defect is only a scoliotic attitude.

Scoliotic attitude resolves automatically by eliminating the causes, e.g. a limb shortening that can be eliminated by a support. Furthermore, it is said that scoliotic attitude can be caused by incorrect positions prolonged in time, especially in sedentary children or children with weak muscles.

Idiopathic scoliosis has peculiar features, such as familiarity. The risk of having a scoliosis is 30% if a parent suffers therefrom and 50% if both father and mother suffer from scoliosis. Therefore, it is very important that a scoliotic parent makes his/her children be controlled during growth, especially at the puberty beginning. Another characteristic feature is sex distribution: evolutionary scolioses appear in 8 cases out of 10 in the females.

Furthermore, it was also hypothesised that the scoliosis' primum movens were an altered programming of the action of the musculus brevis transversospinalis and that the electrical stimulation of the paravertebral musculature was the most appropriate way to the therapy. However, S.P.E.S. (Surface Paravertebral Electric Stimulation) provided good but non optimal results.

Scolioses are classified as follows.
Scoliosis with a primary curve (about 70% of cases), comprising:
   thoracic scolioses (about 25%)—they generally have a right convexity and a lumbar compensating curve which becomes rapidly structured;
   thoraco-lumbar scolioses (about 19%)—they generally have a right convexity and two compensating emicurves;
   lumbar scolioses (about 25%)—they usually are left-convex, and a thoracic compensation curve appears during worsening;
   cervix-thoracic scolioses (about 1%)—usually there is a left convexity and thoracic or thoraco-lumbar compensation curves tend to form.
Scoliosis with double primary curve (about 30% of the cases), comprising:
   scolioses with thoracic and lumbar curve (about 23%)—they are the most frequent ones and generally determine a right thoracic and left lumbar convexity with thoracic or thoraco-lumbar compensation which tend to form;
   scolioses with double thoracic curve—usually the limiting vertebra are T1 and T6 for the upper curve and T6 and T12 for the lower one;
   scolioses with thoracic and thoraco-lumbar curve.

Generally, scolioses tend to get worse quickly in the pubertal period.

Usually, if the scoliosis is not very serious, and shows a minimum vertebral rotation, it is recommended to exercise with specific gymnastics, i.e. the so-called medical or postural gymnastics, which should reinforce the bearing structures supporting the column, thus reducing the worsening of the scoliosis itself.

If, notwithstanding the gymnastics, the scoliosis demonstrates to be nonetheless evolutionary, it is necessary to make the patient wear a corset. This can be of an axillary type (the most commonly used one), or, only when necessary, of a Milwaukee type (e.g. high, with the collar). If the deformation is definitely structured, it can be necessary to use, for a certain period of time, a non-removable corset manufactured with plaster, in order to obtain a better correction.

If the scoliosis is not adequately treated or has a strong evolutionary potential, it can exceed the 40-60 degrees and require a surgical operation. Also in scolioses treated with corsets or surgically it is necessary to do a lot of gymnastics in order to avoid damages to the plastered apparatuses or to the jackets and to facilitate the best result of the treatment. However, the recommended gymnastics must not stimulate column mobilization.

The manufacture of plastered corsets is preceded by a period of mobilizing kinesitherapy and passive or active vertebral traction in order to overcome the paravertebral legamentous musculus retractions and make the correction easier and more tolerated.

Once the preparation period ends, the plastered corset is manufactured according to the so-called Cotrel technique which allows a triple elongation, derotation and side deflexion action (E.D.F.).

In practice, nowadays the treatment strategy remains substantially the same as that described by Hippocrates upon applying his traction and retention table.

In fact, the patient is placed onto the cot with the pelvis fastened by cloth bands which cross above the iliac crests and under traction at the head by means of a chin rest. The elongation is controlled by a dynamometer with traction values corresponding to ⅓ of the body weight. The plastered corset is manufactured and, before setting, the derotation bands and the scapular fixation band with three ends are applied. When the plaster is dry, it is widely fenestrated on the front side, by leaving a push onto the front costal gibbosity and on the rear side at the level of the concavity of the dorsal curve, in order to allow the expansion of the trunk's depressed portion. As a free space forms between plastered push and thoracic wall of the curve convexity portion, felts are added in order to gradually reduce the gibbosity. The shoulders are cut asymmetrically in order to allow retroposition from the convex side and anteposition from the concave side. To or three plastered corsets are manufactured for a total period of six-eight months.

The plastered corset proposed by Risser as from the '30s is useful in particular to overcome the resistance opposed by stiff curves, with relatively short radius of curvature and a significant rotation component. The patient is placed onto a particular “bed” in supine position and with bent hips. The correction fundamental concept is to act with pushes which, by pivoting onto the curve's apex, act under deflexion, thus causing a correction of the side deviation rotation. The plastered corset in its classic scheme is manufactured in two distinct portions which are then re-joined to bring the rachis back to a rectilinear situation.

The scoliosis' bloodless treatment with orthopedic corsets is it be implemented according to the type of curvatures and up to the end of bone maturation.

As Duval Beaupère demonstrated (Duval-Beaupere G., Dubousset J., Queneau P., Grossiord A.—Pour une théorie unique de l'évolution des scolioses. Nouv. Presse Méd., 78, pp. 1141-1146, 1970), the scoliosis evolution continues until the end of the skeletal growth. Therefore, it is necessary to keep until such period the correction obtained by the plastered corsets with orthopedic corsets.

There are several types of orthopedic corsets:
Lionese corset,
La Padula corset,
Boston corset,
Chêneau corset,
Milwaukee corset.

All such corsets are manufactured by rigid materials, nowadays fibreglass valves or rigid steels, very similar, actually, to the metallic jackets designed and used by Ambroise Pare in 1582.

The most important features reported in literature about the scolioses' progressivity can be synthesized as follows:
the evolutiveness can vary up to 20° Cobb/year and generally it has the maximum extent during the puberty growth period which starts at the bone age of 11 years in the girls and 13 years in the boys (Duval-Beaupere G., Dubousset J., Queneau P., Grossiord A.—Pour une théorie unique de l'évolution des scolioses. Nouv. Presse Méd., 78, pp. 1141-1146, 1970);
the worsening critical threshold in the growth period is between 25° and 30° Cobb (Clarisse 1974, Fustier 1980);
in half the cases between 9 and 11 years, before the pubertal growth, there is a period of stability (Duval-Beaupere G., Dubousset J., Queneau P., Grossiord A.—Pour une théorie unique de l'évolution des scolioses. Nouv. Presse Méd., 78, pp. 1141-1146, 1970);
the evolutiveness is directly proportional to the precocity of the deformation onset (Cotrel 1971);
some child scolioses, diagnosed before 3-year age, can be regressive (Mehta M. H.—The Natural History of Infantile Idiopathic Scoliosis. In 5th Symposium, 1976. London, Zorab, pp. 103-123, 1977).

The evolutiveness depends upon the anatomo-radiological shape of the scoliosis (Ponseti I. V., Friedman B.—Prognosis in Idiopathic Scoliosis. J. Bone Jt. Surg., 36-A, p. 1081, 1954). Generally, the short curves, which then comprise a reduced number of vertebra, are the most evolutive ones. The evolutiveness is less, in the development period, passing from the greater double curves to the thoracic, thoraco-lumbar and lumbar ones. The stability in adult age equally depends upon the anatomo-radiological shape and it follows the inverse order: the primary doubles ones, which are the most evolutive in child age, are the most stable in adult age, whereas the lumbar ones become the most unstable ones.

FIGS. 1 and 2 show each the evolution of a respective case of scoliosis treated by the known art methods described so far.

In the first case shown in FIG. 1, view (a) relates to antero-posterior and latero-lateral deformation in a 16 year-old boy at the beginning of the treatment. Dorsal curve D7-D12 was 61°, lumber counter-curve D12-L5 was 41°, R3+.

The boy was treated with three plastered corsets of Risser type, each one for four months, then with Lionese 2 corset.

View (b) shows the first radiographic check six months after the release from the plastered corset and just-worn Lionese corset. Dorsal curve D5-D12 was 340, R5+.

View (c) shows a fourth check three years and a half after release from the last plastered corset, without 30-hour Lionese corset. Dorsal curve D5-D12 was 34°, D12-L5 was 25°, R5+.

View (d) shows the final result. D5-D12 was 38°, D12-L4 was 25°.

View (e) shows with 20 Kg D7-D12 35°, D12-L5 23°.

As per the second case of FIG. 2, view (a) shows the antero-posterior and latero-lateral modifications in a 15-year-old girl at the beginning of the treatment, with D1-D6 30°, D6-D11 51°, D11-L4 26°, R4+.

She was treated with three plastered corsets, each one for four months, then Lionese corset.

View (b) shows the situation at First check six months after ablation of the last plastered corset, just-worn Lionese corset, wherein D1-D6 was 300, D6-D11 was 43°, D11-L4 was 19°, R5+.

View (c) shows the situation at second check two years and a half after release from the last plaster, without 24-month Lionese corset: D1-D6 was 30°, D6-D11 was 41°, D11-L4 was 20°, R5+. It is to be noted that, in this last case, the treatment after the last plastered corset has not been performed correctly by the patient, because she has removed the corset after twelve months without authorization. Nevertheless, the correction has maintained stable (d) thanks to the long immobilization period.

### SUMMARY OF THE INVENTION

From what was illustrated so far, it can be deduced that nowadays scolioses' classification consists mainly in defining them “idiopathic”, i.e. without a known cause, or not and the treatment of idiopathic scolioses mainly consists in coercive methods and in mechanical locks of the column, without any additional conceptual contribution with respect to the theory developed and applied by Hippocrates in 300 a.C. Accordingly, essentially the only purpose of such therapy is not to worsen further the scoliotic deviation.

Therefore, from the analysis of the state of the art reported above, it is clear that up to now medical investigations about idiopathic scolioses have failed to give a true insight into the causes and mechanisms originating them.

Accordingly, the object of the present invention is that of providing a new etiologic approach to the classification, diagnosis and treatment of such pathologies.

This object is reached by a therapeutic method according to claim 1.

### BRIEF DESCRIPTION OF THE DRAWINGS

Other advantages, features and the operation modes of the present invention will be made apparent from the following detailed description of some embodiments thereof, given by way of example and not for limitative purposes. Reference will be made to the figures of the annexed drawings, wherein:

FIGS. 1 and 2 have already been introduced with reference to the prior art techniques;

FIGS. 3A and 3B show a plant and a sectional view, respectively, of a corrective plantar for use in the therapeutic method of the invention;

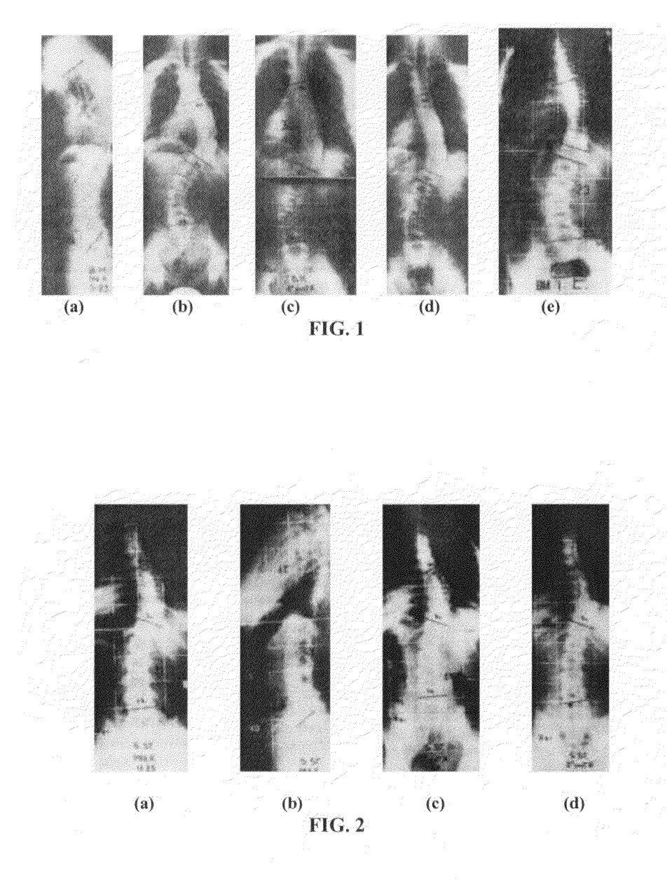

Figures from 4A to 15B relates to respective clinical cases treated by the therapeutic method of the invention.

### DETAILED DESCRIPTION

The present invention originates from the original considerations reported below concerning scoliosis's causes.

The attitude that the human body assumes is surely the wished one, but it is also the possible one in relation to the gravity force and to the fibroelastic capability which it succeeds to express. Plasticity and elasticity, then, are two units of measurement of the body health and of its plastic potential expression. Plasticity and elasticity express both in the anti-gravitational asset of the whole organism and in the range of motion of each single articulation.

Vision, endolymph and otoliths of the inner ear, the proprioceptive information of the column and of the ligaments, the mandibular and the plantar receptors all take part in the perception of the head and body position in space.

Starting from the esoreceptors (plantar sole, inner ear, vision), the individual receives information about his/her own relationships with the outer world. Starting from the endoreceptors (neuromuscular spindles, receptors of tendineous stretch, articular receptors), the adjusting system is enriched by information about the relative positions of the different body segments, the ones in relationship to the others. The posture, then, is not a sum of reflexes, but a polysensorial interaction wherein a set of structures of a different nature interact in order to obtain a result. Each activity or function, then, derives from a series of outer or inner information contribution (input) and it expresses as adaptation phenomenon (output).

The experiments carried out at the beginning of the XX century by Sir C. Sherrigton and Coll. on decerebrate animals have codified the adjustment of the postural tone (The Integrative Action of the Nervous System New York, Charles Scribner's Sons, 1906. Mammalian physiology. Oxford and London, 1919; The Reflex Activity of the Spinal Cord Oxford, 1932; The Brain and Its Mechanism. Cambridge, 1933; Man on His Nature The 1937-38 Gifford lectures, Edinburgh: N.Y.: MacMillan, 1940. Cambridge University Press, 2nd rev. edition 1951, hardcover: ISBN 0-521-06436-8, paperback: ISBN 0-521-09203-5). Such studies have established that there is a non-nervous adjustment and a nervous adjustment. The non-nervous component is represented by the yellow ligaments, iliofemoral ligaments and by the knee's cruciates. The nervous component is represented by a spinal component and by a supraspinal component.

The spinal component is constituted by an afferent system, represented by a proprioceptive component, neuromuscular spindles and musculotendineous organs of Golgi, an articular, cutaneous and visceral component and, at last, a propriospinal component; and by an efferent system, represented by the activation of the antigravitational muscles.

The supraspinal component of the postural tone adjustment is represented by the vestibular, reticular and cerebellar components.

The afferent system is represented by sensitive fibres which play a role in the posture reflexed control and have the following features:
the adequate stimulus for the sensitive endings must be that of gravity and/or of other forces acting onto the various body parts;
during the application of this stimulus the afferent discharge has to be maintained in time;
the central connections of said afferences have to facilitate the motor nuclei of the antigravitary tissue.

The efferent systems are involved in determining the final expression of the postural integration which is determined by the combination of the activated motor nuclei and by the pattern of the motoneuronal recruitment inside each nucleus.

Esteroceptors, in particular, are sensorial receptors able to catch the information coming from the environment and they send them to the Central Nervous System. The universally recognized receptors are located at three main areas: the inner ear, the eye and the plantar cutaneous surface.

As far as the inner ear is concerned, the receptors of the inner ear are accelerometers, which inform about the head motion and position with respect to the gravitary vertical. The vestibular inlet comprises a semi-circular system and an otolithic system. The semicircular system is a system with three arciform channels located in three planes perpendicular thereamong, sensible to the angular accelerations (head rotation). The semi-circular channels do not take part in the equilibrium's fine adjustment, as their minimum threshold of sensibility to the accelerations is greater than the oscillatory accelerations inside the fine postural system; on the contrary, the system intervenes in the dynamic equilibrium. The otolithic system is included in two vesicles: the saccule and the utricle, sensible to the gravity and to the linear acceleration. The inner ear perceives the angular accelerations (head rotation) by means of the receptors located in the semicircular channels and the linear acceleration by means of the otricule/saccule system. It seems that only the latter take part in the fine postural adjustment. In fact, already in 1934, Tait J. and Mac Nelly W. H. (John Tait, W. J. McNally Philosophical Transactions of the Royal Society of London. Series B, Biological Sciences, Vol. 224, No. 513—Dec. 24, 1934—pp. 241-286) showed that the denervation of the semi-circular channels does not interfere with the muscle tone, whereas the utricle one translates into deep perturbations of its partition.

In order that information coming from the inner ear be able to be interpreted by the Postural Tonic System, such information has to be compared to the proprioceptive information which allow knowing the head position with respect to the trunk and the trunk's one with respect to the ankles and above all to the information of podalic pressure, which remains the only fixed reference for the whole organism.

As per the eye, the visual inlet, thanks to the retina and to the peripheral vision, allows the postural stability for the anteroposterior motions. On the contrary, for the right-left motions, the central vision becomes predominant. The visual inlet is active when the visual environment is near; if the visual target is far five meters or more, the information coming from the visual receptors become less important and are not to be taken into consideration by the Postural Tonic System.

In order that the Postural Tonic System can utilize the visual information for keeping the equilibrium, it is necessary that such visual information be compared to that coming from the inner ear and by the plantar support.

The eye is not indeed able to discriminate whether the sliding of images onto the retina is due to the eye motion, to the head motion or to the motion of the whole body mass.

For the role of the plantar cutaneous surface, the Inventor has developed the following original observations.

The plantar esteroceptors allow placing the whole body mass in relationship to the environment, thanks to pressure measures at level of the plantar cutaneous surface. The latter represents the constant interface between environment and Postural Tonic System. It is full of receptors and it has a very high sensibility threshold (the baropressor mechanoceptors perceive even the pressures of 0.3 g). They provide information about the oscillations of the whole body mass and then they behave like a “stabilometric platform”. The plantar information is the only one deriving from a fixed receptor, directly in contact with an immobile, but still various, environment, represented by the ground.

Then, in light of these concepts, the adaptation to keeping a biped and ortostatic posture has involved for human beings a huge effort in energy and recruitment of tissues and specific structures, the only aim thereof being overcoming the force of gravity. All functions of the human body, as well as in all organisms equipped with a Central Nervous System, express by activating the reflexed circuits.

Under reflexed nervous mechanism each motor or secretory response is meant, independently from the conscience's will or control, determined by excitations arisen in peripheral receptors and propagated to the Central Nervous System along afferent neurons and then sent to the effector organs by means of efferent neurons. Therefore, the term “reflexed” designates not only the forward and back path of the excitations, but also the fixity, automatism and ineluctability of the reflexed responses themselves. The reflex, then, is a response to stimuli of various nature or with different origin, programmed in advance by the organism, in order to evoke an immediate reaction useful to various purposes.

The reflexed activity concept was introduced in physiology by Hales and Whytt (Hales S. Statistical assays: containing haemastaticks. London, UK: Innys, Manby and Woodward, 1733 2. Whytt R: Observations on the Dropsy in the Brain Edinburgh: J. Balfour, 1768), after an experiment carried out onto a beheaded frog. By applying a small piece of paper soaked in acetic acid onto the skin of the abdomen of a beheaded frog, the frog performs with one or both lower and/or upper limbs the motions useful to release it from the irritative stimulus.

Therefore, the hypothesis that a dysfunctional situation able to generate somatic deviations and, in case, also symptoms, could originate exactly from theses reflexed circuits, if altered, is well-founded.

Literature (Kavounoudias A, Roll R, Roll J P. J Physiol. 2001 May 1; 532 (Pt 3):869-78. Foot sole and ankle muscle inputs contribute jointly to human erect posture regulation; Inglis J T, Kennedy P M, Wells C, Chua R. Adv Exp Med Biol. 2002; 508:111-7. The role of cutaneous receptors in the foot; Mergner T, Maurer C, Peterka R J. Prog Brain Res. 2003; 142:189-201. A multisensory posture control model of human upright stance; Liu W, Kim S H, Long J T, Pohl P S, Duncan P W. Neurosci Lett. 2003 Jan. 9; 336(1):1-4. Anticipatory postural adjustments and the latency of compensatory stepping reactions in humans; Chiari L, Rocchi L, Cappello A. Clin Biomech (Bristol, Avon). 2002 November-December; 17(9-10):666 Stabilometric parameters are affected by anthropometry and foot placement) states that the esteroceptive and proprioceptive reflexes, indeed, give tone to the muscle, therefore indirectly supporting the hypothesis that tone alterations, or the presence of asymmetric muscle tone in symmetric muscle groups, is to be ascribed to disharmonic or not uniform sensorial afferences.

Based on the concepts expressed so far, it can be stated that almost the totality of the dysfunctional syndromes, therefore without anatomical and/or histological alterations of the locomotor apparatus' tissues, be due to a condition that we could define “Reflected Dysfunctional Syndrome”.

Depending upon the number of esteroceptors involved in originating anomalous neuroceptorial information, such syndrome can be defined Simple or Complex.

Therefore, we define Simple Reflected Dysfunctional Syndrome the one coming mainly from a single esteroceptor and which causes the clinical picture labelled as “Somatic dysfunction”.

Complex Reflected Dysfunctional Syndrome, instead, is the one wherein anomalous neuroceptorial information converge, coming mainly and at the same time from several esoreceptors. This complex informational dysfunction, coming at the same time both in caudo-cranial and cranio-caudal direction onto the same muscle-ligament structures, determines alterations and disharmonic tensions of these structures themselves onto all three space planes, at the same time, in practice by triggering also torsional phenomena by acting both onto the longitudinal and the horizontal segmentary components of the column.

The vertebral column, in fact, is formed not only by the bone vertebra, but also by disks, ligaments, capsules, muscles. It is organized in two pillars: the front one comprises the vertebral bodies with cartilagineous disks, the interposed disk and the corresponding portion of the front and rear longitudinal ligament, and it plays a significant function as far as the stability is concerned; the rear one comprises the neural arc with its spinous and transverse apophyses, the articular cartilagineous surfaces, the capsulae ant the segmentary ligaments, as well as the corresponding inter-segmentary musculature and it is important above all for the rachis motion.

Nevertheless, the two compartments, even if distinct and with specific functions, have the possibility of mutually integrating or, even, changing the role therebetween under particular conditions and positions of the rachis in the space. The single motion segments constitute, as a whole, three bearing systems, one of which is frontal (bodies and disks) and two of which are posterior (articular). They develop onto the longitudinal plane and they are connected, on the horizontal plane, at each level, by “connecting stirrups” (penundles and laminae). This “hinged”-pillar-like architecture, if on one side guarantees to the structure an intrinsic stability under conditions of morpho-functional normality of all the components thereof, on the other side can be the cause of torsional phenomena in presence of morphological normality of its stiff and semi-stiff structures (vertebrae and disks), and of a functional alteration of its elastic structures.

This is what can be observed in idiopathic scolioses.

Accordingly, we can define idiopathic scoliosis as a complex reflected dysfunctional syndrome.

In many years of clinical practice in the functional evaluation of the neurosensorial afferences coming from the esoreceptors and having the purpose of fulfilling both antigravitational and dynamic motor functions, the Inventor observed that in idiopathic scolioses the contemporary dysfunction of two esoreceptors is present, namely the oculomotility and the plantar threshold for 82% of the cases and of the vestibule and of the plantar threshold in the remaining 18% of the cases.

Apart from this, in the patients affected by idiopathic scoliosis a bad respiratory function with arrest of diaphragm motion, and also a bad intestinal function, often with usual constipation and sometimes persistent constipation, post-prandial swelling, flatulence and so on, were also always observed.

Such situations can be observed also during the radiographic examination (rachis in toto) which usually is performed to evaluate the extent of the scoliosis itself.

Another almost always existing alteration, and almost always secundary to scoliosis, is a cross-bite-type maloocclusion.

This global interpretation of the idiopathic scoliosis pathology led the Inventor to a therapeutic method wholly different from what has been performed sofar.

In particular, the therapeutic method of the invention is not based, as in the prior art, upon stiff corsets and mechanical pushes on gibbuses, as wishing to smooth and elongate passively the trunk and the column, but upon a realignment of the altered neuroreceptorial afferences, without neglecting the analysis and the correction both of the respiratory function and of the intestinal function.

The therapeutic method according to the invention provides for the re-modulation of sensorial tactile and pressorial afferences coming from the foot plant by the application of fibrous-elastic inserts arranged at the insertion of the intrinsic muscles of the foot plant in hypotone, so as to obtain a vertical pressure stimulation for the whole body.

The determination of the hypotonic muscles is carried out both by identifying the hyperpressure points as shown in a so-called “podogram” (i.e. a graph showing the pressure distribution under the foot sole while the patient is in a standing relaxed posture—the areas associated with greater pressures are those wherein the muscles are not able to maintain the bones raised from the ground in a physiologic way) and by using a dynamometer, e.g. that described in U.S. Pat. No. 6,948,365. This latter tool is able to evaluate in a more precise way the muscular work in relation with the neurosensorial afferences coming from the foot plant.

Preferably, the foot plant points interested by the method are selected in a group comprising:
flexor hallucis brevis,
adductor hallucis,
flexor digiti quinti brevis,
abductor hallucis,
abductor digiti quinti,
cuneous pronator, and
cuneous supinator.

The therapeutic effect takes place especially during walking, wherein the informative reflex circuits are mostly stimulated by the aforementioned pressorial stimulation.

According to the method of the invention, in case of a roto-scoliosis the patient has to wear the stimulation orthosis during the whole day in order to obtain appreciable structural modifications at the column. Preferably, at least two continuous walkings have to be undertaken each day. Such walkings can be substituted by the use of revolving carpet, at a speed of 3 km/h.

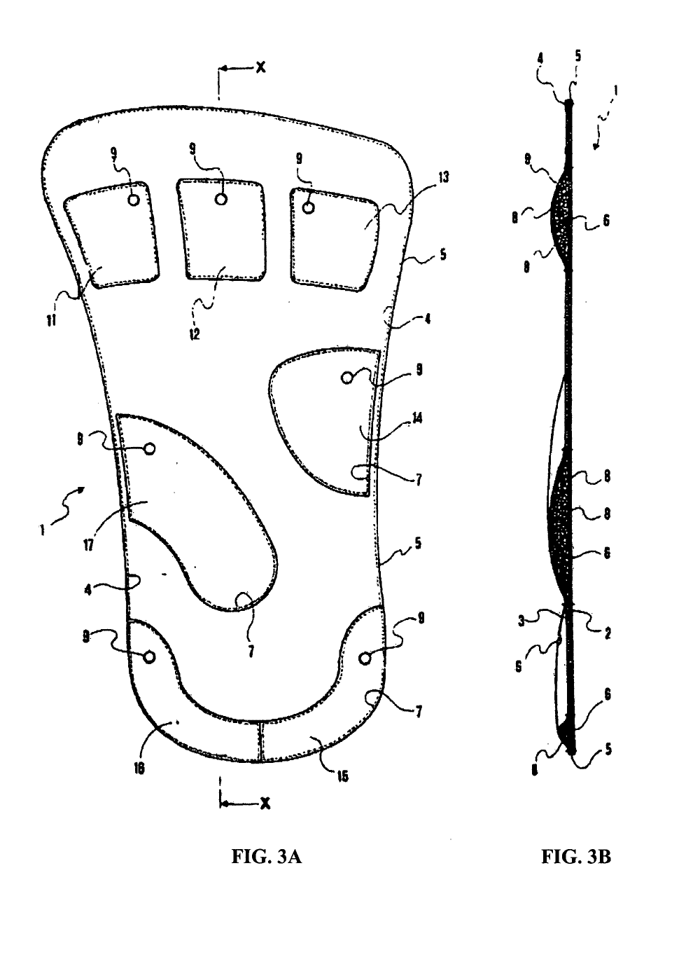

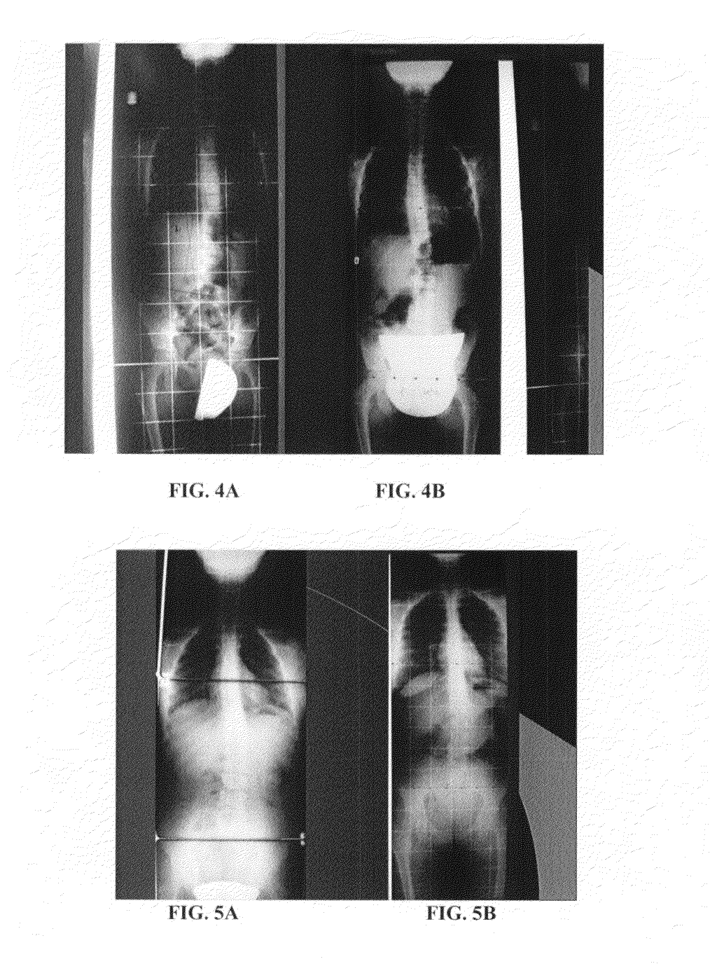

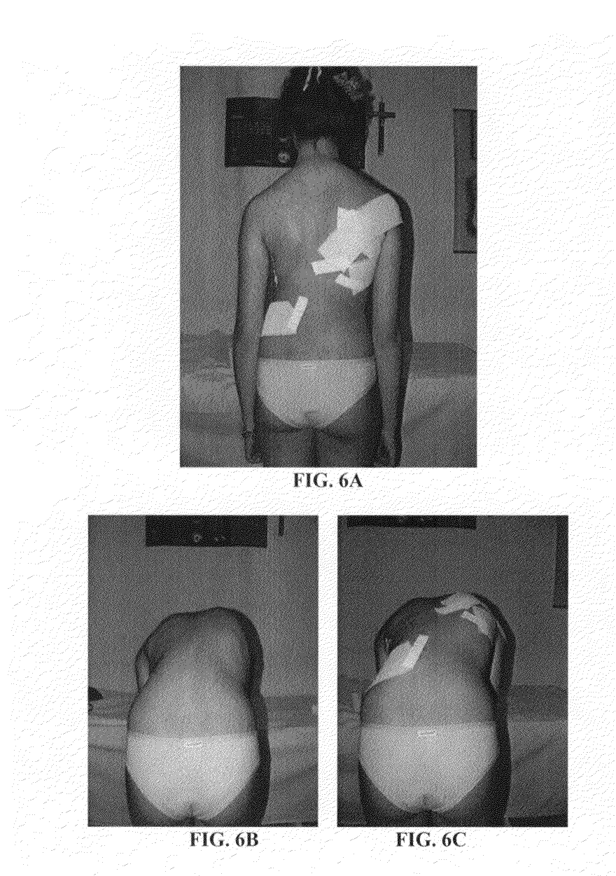

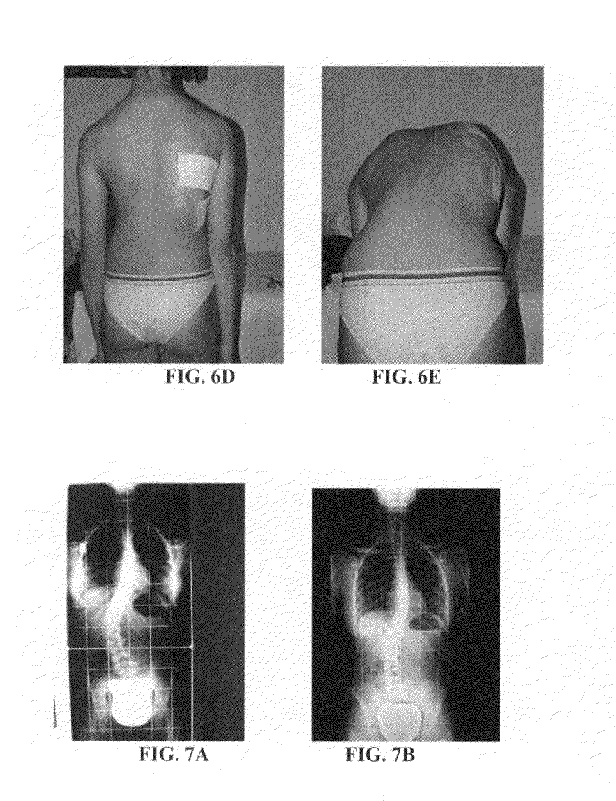

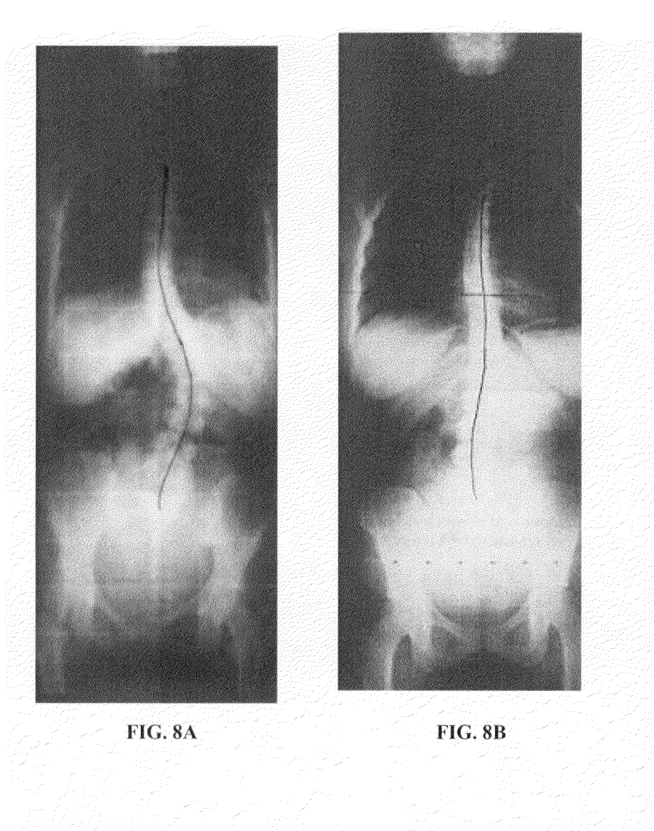

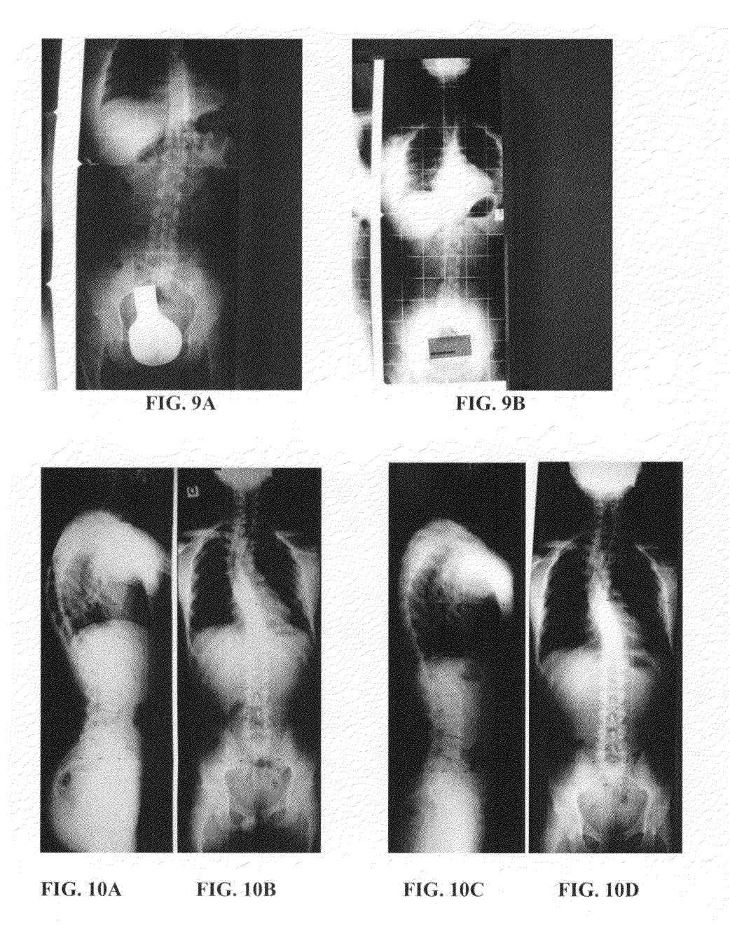

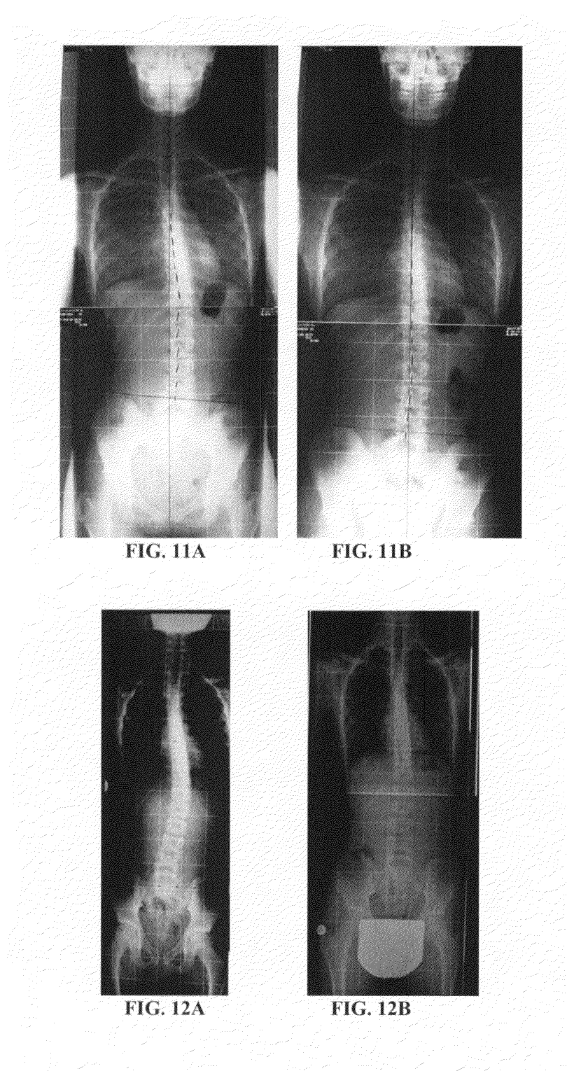

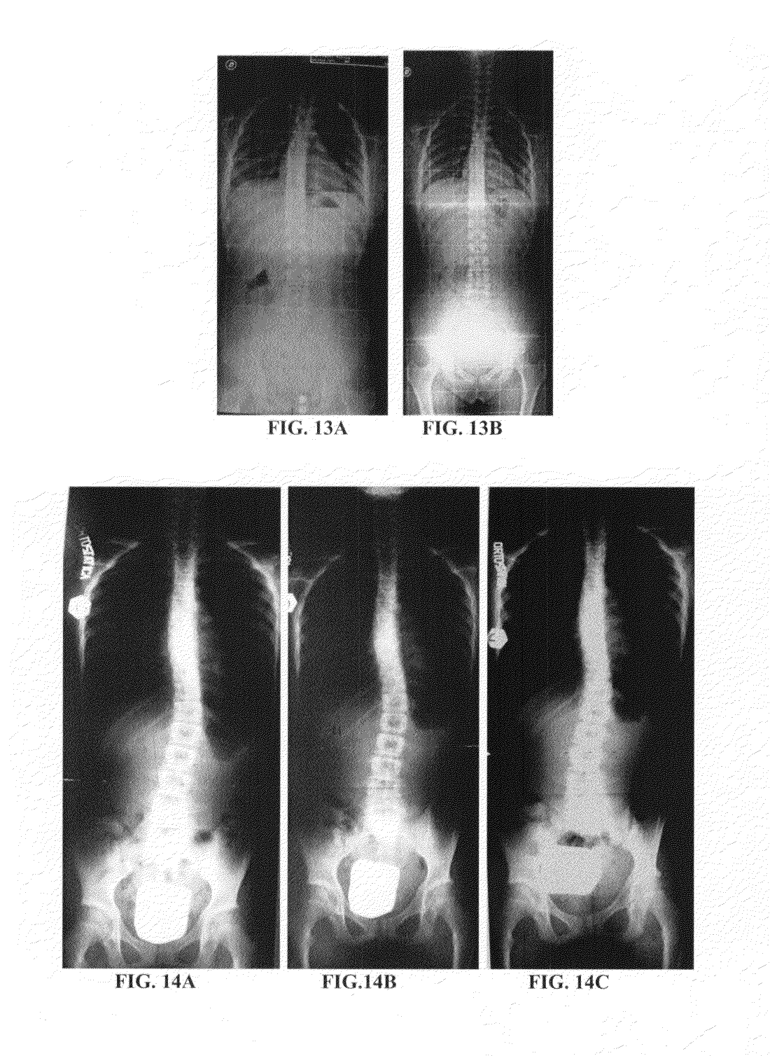

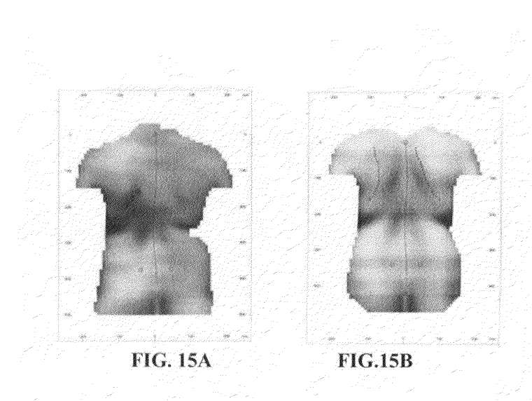

FIGS. 3A and 3B show an example of a foot insole, or plantar, 1 apt to perform the aforementioned stimulation of the foot plant.

Plantar 1 comprises a plurality of swellings, substantially located at proprioceptors and pressoceptors of the foot sole. Said proprioceptors and pressoceptors, of superficial, articular and deep kind, are substantially located at muscle insertions of the sole. In the present example the swellings are formed between a first and a second layer 2 and 3 of plantar 1 at proprioceptors and pressoceptors of the sole.

In particular, the swellings are defined by a plurality of respective alveoli 6 the perimeters of which are defined and strengthened by respective linear seams 7.

Each alveolus 6 is filled with discrete elastic particles, substantially irregularly shaped, having facets and corners on surfaces thereof, and being made of substantially non-allergenic rubber material, to form said swellings. To this purpose, each alveolus 6 includes an opening 9, located close to its respective linear seam, which can be opened to enable filling of the alveoli 6 through a cannula or similar device. Once the alveoli have been filled the openings 9 can then be closed.

The thickness of each swelling, which is obtained due to filling with the particles, and to the natural elasticity of the material of which layers 2 and 3 are made (e.g. alkantara and rubber), is about 3 mm.

The shape, thickness and elasticity of each swelling are pre-established for a proper reflexotherapic stimulation of proprioceptors and pressoceptors of the sole. In particular, the filling of the alveoli 6 is performed on the basis of therapeutic prescriptions related to the patient who has to wear the plantar 1.

Each plantar 1 has seven elastic swellings, with different shapes according to their locations, at respective proprioceptor and pressoceptor areas of the sole. In particular a first elastic swelling 11, at the abductor hallucis, a second swelling 12 for the flexor hallucis brevis, a third swelling 13 for the flexor digiti quinti brevis, a fourth swelling 14 for the abductor digiti quinti, a fifth swelling 15 for the cuneus supinator, a sixth swelling 16 for the cuneus pronator and a seventh swelling 17 for the abductor hallucis.

According to another aspect of the therapeutic method of the invention, a proper oculomotricity is stimulated by use of a collyrium containing inosyne-mono-phosphate, which is an amminoacid apt to improve the oculomotor muscles' contractile capacity and dedicated exercises of orthoptics.

According to a further aspect of the therapeutic method of the invention, a vestibular rehabilitation is carried out, by means of dedicated exercises, such as static and dynamic boite, mire point with rotating or still head, to be carried out with bare feet onto a proper pad.

According to a still further aspect of the therapeutic method of the invention, stimulation exercises for diaphragm mobility by avoiding use of the accessory respiratory muscles are carried out, with a recovery of a physiologic function of pulmonary expansion with increase of the ventilatory volume and minor tractions onto the rachis dorsal segment. Such exercises may involve the use of a device as that of Italian patent application no. RM2006A000628, which is included in the filing documentation of the present application.

According to another aspect of the method of the invention, a stimulation of a proper intestinal peristalsis is carried out, both for reactivation of the physiologic pacemaker represented by the mechanoceptors in the serosa of gastric bottom which activate such movement due to the pressure exerted onto them by the lowering diaphragm during the inspiratory phase, and for the re-balancing of the intestinal flora by living ferments, which reduces putrefactive events and autologous gas formations.

The consequence is a normal intestinary transit, a normalization of faeces evacuation, and with them of all the toxins originating from fermentation of alimentary scoria.

This latter aspect is very important, as both the small and large intestine are suspended in the abdomen and linked to the rachis lumbar segment by the peritoneum. Accordingly, asymmetric swellings of such organs determines asymmetric stresses onto the lumbar column and the rachis.

FIGS. 4A and 4B show an example of the situation before and after, respectively, the treatment by the method of the invention.

In the case shown, the RXs of a thirteen year old girl are displayed, having a lumbar scoliosis and important intestinal occupation. The RX of FIG. 4B shows the situation after one month of treatment with lactic living ferments, when a reduction of the intestinal gases, a reduced distension of intestinal curves and a reduced deviation of the column and the pelvis are observed.

FIGS. 5A and 5B show another example of a girl patient with scoliosis, always before and after the treatment by the method of the invention, respectively.

FIG. 5A shows a column deviation as well ad a highly raised and contracted diaphragm, a triangular thoracic cavity and a deformed heart. In the abdominal cavity a great distension of the intestinal curves was observed.

FIG. 5B shows, in addition to a clear improvement and normalisation in the column arrangement, also a greater pulmonary expansion, an improved heart and the absence of intestinal stasis in the abdomen.

Finally, as a further aspect of the invention, in presence of costal thoracic or lumbar gibbosities, elastic tractions are carried out by small adhesive elastic bands, which stimulate cutaneous mechanoreceptors in metameric seat, without coertions or pressure upon the gibbosities themselves but only with elastic stresses that, during dedicated exercises, tend the sole skin in a complementary verse with respect to the bone deformation.

The bending is typically to be kept for ten days.

FIG. 6A shows an example of elastic bending exerting a cutaneous stimulation upon scoliotic gibbosities.

From FIGS. 6B and 6C it can be observed that the bending, even immediately after its application, reduces the raising of the gibbosities and the shoulder rotation with respect to the pelvis.

FIGS. 6D and 6E show a second bending that, in the present example, can be applied after about one month from the first one and typically maintained for ten days. From such figures it can be observed that the areas to be stimulated are reduced and that the behaviour of the shoulder and the pelvis has improved, both in the erect posture and during a bending test.

Therefore, according to the method of the invention, the neurosensorial afferences coming from the feet sole are normalized and modulated, so as to reinforce and uniform the vertical anti-gravitational component of the whole organism and keep constant and physiological the intra-articular spatiality.

Then, by normalizing and modulating the neurosensorial afferences coming from the cranial esoreceptors, the horizontal stabilization components of the whole organism and of the vertebral column are reinforced and uniformed.

Succeeding in obtaining a functional improvement, both in vertical and horizontal sense, of the fibro-elastic bearing structures of the column allows an increase in the performance of the whole body. If our organism is considered as a system represented by a set of sub-systems, each one with specific functions, but which, once joined, determine the health of the set, it is well understood how it is important that each single structure plays its function at best. In fact, the performance of a system, whichever is its organization, is given from the sum of the performance of each sub-system. If then one succeeds in recognizing the dysfunction and in intervening on the rebalancing of the function of the altered sub-systems, a summation with increase in the positive effects onto the whole organism is obtained.

Then, the purposes of this new framing is not to try not to worsen the situation—as in the prior art—but to intercept the etiologic cause of the problem and to solve it in order to obtain a more physiological spatial arrangement of the column with a true vertebral derotation, decrease in the gibbuses' salience and a huge improvement of both radiographic and aesthetic asset of the trunk.

Another important consequence of such treatment is that the organism regains the intra-toracic and intra-abdominal physiological spatialities, thus allowing an improvement in the function of the apparatuses and of the inner organs.

FIGS. 7A and 7B show the RXs of a 35 years old woman patient before and after, respectively, four years of treatment with the method of the invention, and particularly with the plantar disclosed above.

FIGS. 8A and 8B show the RXs of a 54 years old woman patient with a lumbar scoliosis 52° Combs. As shown in FIG. 8B, after 3 years of treatment with the aforementioned insole the lumbar scoliosis was reduced to 18° Combs.

FIGS. 9A and 9B show the RXs of a 38 years old patient with a lumbar scoliosis and lumbago. As shown in FIG. 9B, the column asset was completely corrected.

FIGS. 10A to 10D show the RXs of a 20 years old male patient with dorsal hyperkyphosis and dorsal scoliosis, before the treatment and after one year of treatment, respectively, in lateral (FIGS. 10A and 10C) and frontal (FIGS. 10B and 10D) projections.

Also in this important pathological situation, after one year of treatment with said plantar a significant improvement in the radiographic asset of the whole column, both in a lateral and frontal projection. Also observed are a change in the intra-thoracic spaces and a reduction in the diaphragm cupola, as seen in the lateral projection.

FIGS. 11A and 11B show the RXs of a 16 years old woman patient with a deviation in the column and an asymmetry in the pelvis and scapular girdle, before the treatment and after fourteen months of treatment with the plantar, respectively. An important improvement of the rachis and girdle asset is observed. Moreover, a greater expansion of the ribcage and a reduction in the diaphragm block are also observed.

FIGS. 12A and 12B show the RXs of a 16 years old male patient with a significant deviation in the column and an important asymmetry in the pelvis and brachial girdle, before and after five months of treatment with the plantar, respectively. The patient had already used a Boston corset for one year.

FIG. 12B shows a clear improvement in the asset of the whole trunk.

FIGS. 13A and 13B show the RXs of a 24 years old women patient with a significant deviation in the dorsal column and an important asymmetry in the pelvis and shoulders, before and after one year of treatment with the plantar, respectively. A clear improvement in the cingular and rachis arrangement and a reduction in the diaphragm block are observed.

FIGS. 14A to 14C show the RXs of a 34 years old patient with dorso-lumbar scoliosis, before the treatment and after eight months and one year of treatment with the plantar, respectively. A reduction of the scoliotic curves and a recovery in the pelvis symmetry are observed.

Finally, FIGS. 15A and 15B show the changes in the back asset in a 28 year old women patient after one year of treatment with the plantar.

The present invention has been hereto described with reference to a preferred embodiment thereof. It is understood that other embodiments might exist, all falling within the concept of the same invention, and all comprised within the protective scope of the appended claims.

1. A therapeutic method for the correction of scoliosis, comprising a step of applying a pressure stimulation at one or more selected insertion points of intrinsic muscles of the foot plant, so as to affect sensorial afferences coming from the foot plant.

2. The therapeutic method according to claim 1, wherein said stimulation is performed by fibrous-elastic inserts arranged at said selected point(s).

3. The therapeutic method according to claim 1, wherein said stimulation is performed by a foot insole.

4. The therapeutic method according to claim 1, wherein said stimulation is applied at one or more locations selected among: adductor hallucis, flexor hallucis brevis, flexor digiti quinti brevis, abductor digiti quinti, cuneus supinator, cuneus pronator and abductor hallucis.

5. The therapeutic method of claim 1, comprising a further step of cranial receptors' stimulation.

6. The therapeutic method of claim 5, wherein said step of cranial receptors stimulation is carried out by stimulating oculomotricity.

7. The therapeutic method of claim 6, wherein said step of oculomotricity stimulation is carried out by use of a collyrium.

8. The therapeutic method of claim 1, comprising a further step of vestibular rehabilitation.

9. The therapeutic method of claim 1, comprising a further step of diaphragm mobility stimulation.

10. The therapeutic method of claim 1, comprising a further step of intestinal peristalsis stimulation.

11. The therapeutic method of claim 1, comprising a step of applying elastic stresses at thoracic or lumbar gibbosities.
